(19) United States
(12) Patent Application Publication
(10) Pub. No.: US 2017/0297174 A1
(43) Pub. Date: Oct. 19, 2017

(54) METHOD AND APPARATUS FOR PLIERS

(71) Applicant: Ronald Livingston, Piscataway, NJ (US)

(72) Inventor: Ronald Livingston, Piscataway, NJ (US)

(21) Appl. No.: 15/099,149

(22) Filed: Apr. 14, 2016

(51) Int. Cl. B25B 7/12; B25B 21/00

(52) U.S. Cl. CPC B25B 7/12; B25B 21/00

(57) ABSTRACT

An apparatus including a first pliers handle having a first end and a second end; a second pliers handle having a first end and a second end; a first pivot pin which connects the first pliers handle, at a location between the first end and the second end of the first pliers handle and the second pliers handle at a location between the first end and the second end of the second pliers handle; and a first belt having teeth. The first belt having teeth may be configured to rotate while the first pliers handle remains stationary with respect to the second pliers handle. The first belt having teeth may be configured to be detached from the first pliers handle and the second pliers handle. The apparatus may include a motor located for rotating first belt while the first pliers handle remains stationary with respect to the second pliers handle.

### FIELD OF THE INVENTION

This invention relates to improved methods and apparatus concerning pliers.

### BACKGROUND OF THE INVENTION

There are various devices known in the prior art for pliers.

### SUMMARY OF THE INVENTION

In at least one embodiment, a pair of battery-powered pliers are provided. The battery powered pliers provide increased torque and turning power for fasteners and a wide variety of objects.

The battery powered pliers may be produced from tool grade steel and plastic and may feature the necessary electrical and mechanical components. The battery-powered pliers may measure eight to twelve inches long.

In at least one embodiment the apparatus may have an exterior configuration which may be similar to or the same as a conventional pair of pliers. However, the jaws and the interior of the lower handle may be modified so that this tool can be used with increased power.

A rechargeable battery may be housed in the bottom tip of the lower handle. A port may be provided that would accept the cord from a charger and would be positioned directly below the rechargeable battery.

A motor may be housed within the lower handle as well. A series of buttons may be embedded within this handle to control the function of the motor. There may be buttons dedicated to powering this tool and forwarding or reversing the function of the motor. In addition, a jaw lock button would be integrated into the design of the handle. The motor would be connected to a system of gears that would be connected to rotating jaws. The jaws may rotate clockwise or counterclockwise depending upon the forward or reverse motion of the motor and are removable, in at least one embodiment. The clockwise rotation of the jaws would tighten a fastener, such as a nut located on a bolt, or another object while the counterclockwise motion would loosen the fastener, such as a nut located on a bolt, or another object.

In at least one embodiment a battery-powered pair of pliers is provided that can be used with increased power and turning effectiveness.

The appealing features of at least one embodiment, are its ease of use, convenience, durability, power, effective tightening and loosening functions, timesaving qualities and efficiency, cost effectiveness, reduction of physical strain, and safety qualities.

One or more embodiments may not be adjustable, but alternatively, may come in different sizes so that the apparatus can be utilized by commercial workers such as trades people, construction laborers, general maintenance personnel, and automotive mechanics.

In at least one embodiment, an apparatus is provided which includes a first pliers handle having a first end and a second end; a second pliers handle having a first end and a second end; a first pivot pin which connects the first pliers handle, at a location between the first end and the second end of the first pliers handle and the second pliers handle at a location between the first end and the second end of the second pliers handle; and a first belt having teeth.

The first belt having teeth may be connected to the first pliers handle and located nearer the first end of the first pliers handle than to the second end of the first pliers handle. The first belt having teeth may also be connected to the second pliers handle and located nearer the first end of the second pliers handle than to the second end of the second pliers handle. The first belt having teeth may be configured to rotate while the first pliers handle remains stationary with respect to the second pliers handle. The first belt having teeth may be configured to be detached from the first pliers handle and the second pliers handle.

The apparatus may further include a motor located within either the first or second pliers handle, and a power source located within either the first or second pliers handle. The power source may be configured to power the motor to rotate the first belt while the first pliers handle remains stationary with respect to the second pliers handle.

In at least one embodiment, a method is provided which may include causing a first belt having teeth to rotate while a first pliers handle and a second pliers handle remain stationary. The first pliers handle, second pliers handle and the first belt having teeth may be configured as previously described. The first belt having teeth may be configured to be detached from the first pliers handle and the second pliers handle as previously described. The first belt having teeth may be configured to be controlled by a motor located within either the first or second pliers handle; wherein the motor is configured to be controlled by a power source located within either the first or second pliers handle; and wherein the power source is configured to power the motor to rotate the first belt while the first pliers handle remains stationary with respect to the second pliers handle.

### BRIEF DESCRIPTION OF THE DRAWINGS

FIG. 1 shows a top view of a device in accordance with an embodiment of the present invention;

FIG. 2 shows a simplified block diagram of various components for use with the device of

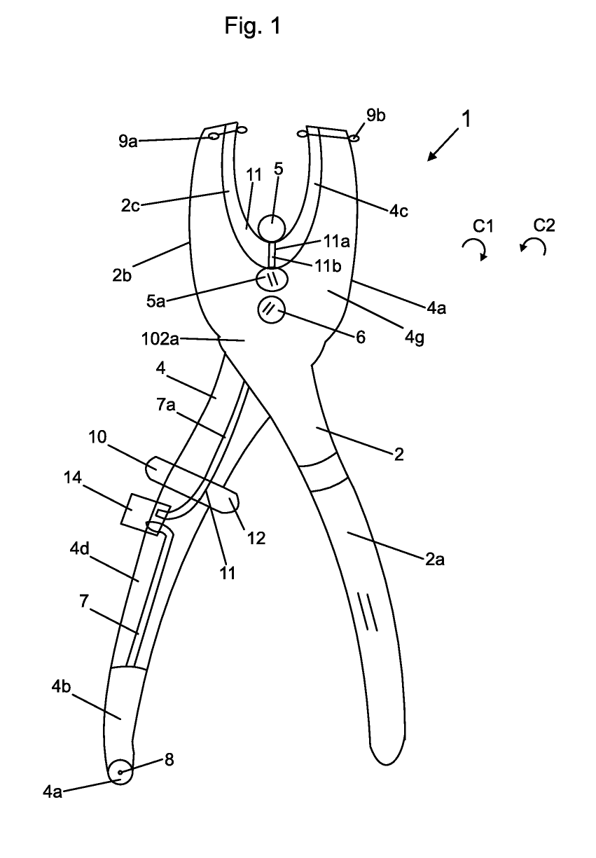

FIG. 1;

FIG. 3 shows a removable belt including teeth that can be attached to the device of FIG. 1 to form a complete apparatus, wherein the belt can be rotated clockwise in the direction C1 or counterclockwise in the direction C2 as shown by FIG. 4;

FIG. 4 shows the removable belt attached to the device of FIG. 1 to form a complete apparatus; and

FIG. 5 shows a nut on a bolt which can be rotated to unscrew the nut from the bolt by the rotation of the belt of FIG. 3.

### DETAILED DESCRIPTION OF THE DRAWINGS

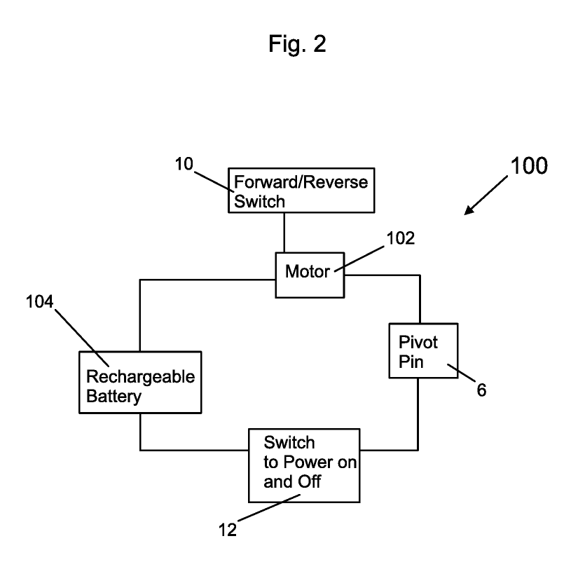

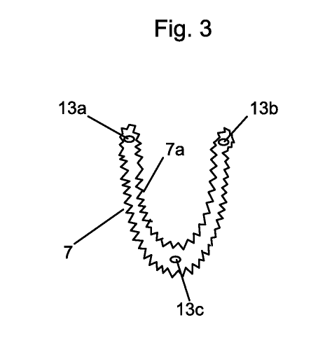

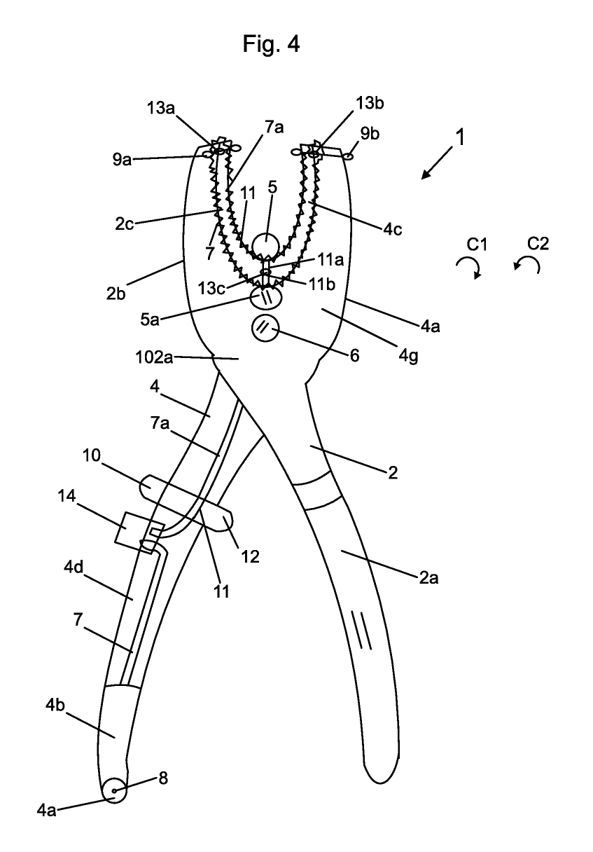

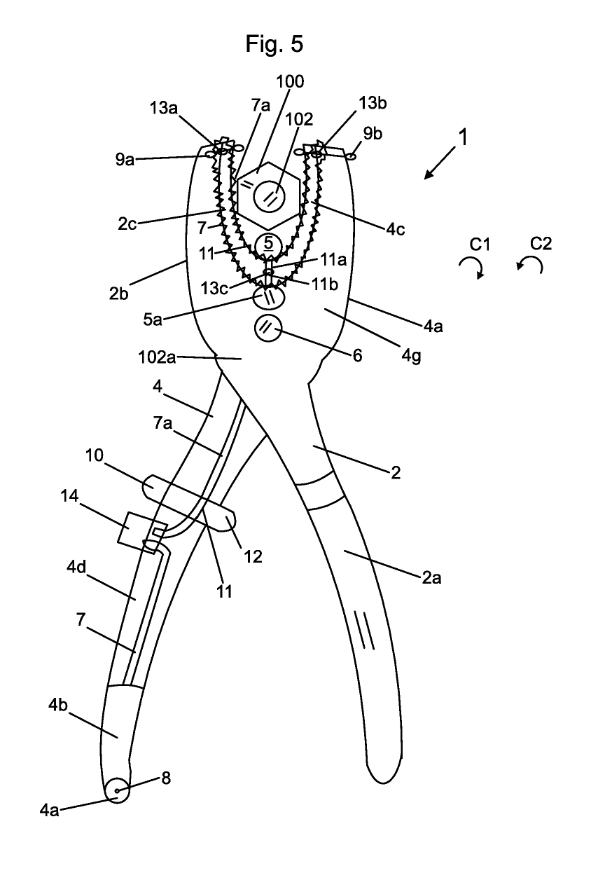

FIG. 1 shows a top view of a device 1 in accordance with an embodiment of the present invention. FIG. 2 shows a simplified block diagram of various components for use with the device 1.

Referring to FIG. 1, the device 1 may be generally in the form of a pair of pliers. The device 1 may include sections, handles, or portions 2 and 4, drive pinion 5 and 5a, drive pinion jaw locking clip 11a and 11b and holding pin 6 an electrical power cord port, terminal or insert region 8, a reverse switch and/or button 12, a forward switch and/or button 10, a forward switch and/or button 11, and a pressure sensitive trigger button 14.

The section, handle, or portion 2 is pivotally mounted to the section, handle or portion 4, so that section 2 and section 4 connect and open and close, as shown in FIG. 1.

The section 2 includes portion 2a, portion 2b, and inside opening 2c. The section 4 includes portions 4a, 4b, 4g, and inside opening 4c.

The device 1 also includes an opening 11 in which the inner teeth belt or bit, including teeth belt 2d, shown in FIG. 3, will be placed.

FIG. 3 shows a removable belt 7 including a plurality of teeth 7a that can be attached to the device 1 of FIG. 1, as shown in FIG. 4, to form a complete apparatus, wherein the belt 7 can be rotated clockwise in the direction C1 or counterclockwise in the direction C2 as shown by FIG. 4. FIG. 4 shows the removable belt 7 attached to the device 1 of FIG. 1 to form a complete apparatus. The removable belt 7 is attached by inserting pins of components 9a and 9b through openings of components 13a and 13b, and a pin of component 11b through opening 13c, and aligning the teeth with the drive pinion 5 and 5a to thereby attach belt 7 to the device 1, as shown by FIG. 4.

FIG. 5 shows a nut 100 on a bolt 102, wherein the nut 100 can be rotated to screw or unscrew the nut 100 from the bolt 102 by the rotation of the belt 7. One or more teeth 7a of the belt 7 engage the nut 100, and when the belt 7 rotates the nut 100 also rotates in order to screw or unscrew the nut 100 from the bolt 102 (depending on the direction of rotation of the belt 7).

Referring to FIGS. 1 and 2, in operation, an individual may push or otherwise activate the forward switch 10 and then push or otherwise activate the pressure sensitive trigger 14 to power the speed of the inner teeth belt 7 or bit section, which may include, inner teeth belt 7 and teeth 7a. This causes the motor 102 shown by FIG. 2 but not in FIG. 1, located under dashed lined area 102a shown in FIG. 1, powered by the rechargeable battery 104 to rotate the drive pinion and gears 5 and 5a, in a forward or clockwise direction C1 shown in FIG. 1, to rotate the inner teeth belt 7 and the teeth 7a. The battery 104 is located within the handle 4 in at least one embodiment. In at least one embodiment, the section, handle or portion 2 is fixed to the holding pin 6. The holding pin 6 is rotatably mounted to the motor 102 which is fixed and embedded inside of the handle or section 4 typically underneath the handle or section 2. The holding pin section 6, allows for the opening and closing of the handles section 2 and section 4 for the gripping of objects. Commercial grade plastic may be provided for section 2b and section 4a to enclose the inner teeth belt section 7. The inner teeth belt section 7 rotates around mechanical spin wheel 13a, 13b, 13c and clip or lock into 9a, 9b and 11a, 11b of the drive pinion section 5 and 5a. The inner teeth belt 7 rotates within a region defined by the plastic casing of components 2c, 4c and 11.

In at least one embodiment, when the pressure sensitive trigger 14 is not activated, i.e. turned off, the inner teeth belt 7 cannot be rotated, but rather the handle or section 4 and handles or sections 2 and 4 open and close with respect to each other.

When the pressure sensitive trigger 14 is activated, i.e. turned on, and the forward switch 10 was the most recently activated switch of switches 10 and 12, the drive pinion and gears 5 and 5a will cause the inner teeth belt or section 7 to rotate in a clockwise direction C1

When the pressure sensitive trigger 14 is pressed, and the reverse switch 12 was the most recently activated switch of switches 10 and 12, the drive pinion and gears 5 and 5a will cause the inner teeth belt or section 7 in a clockwise direction C1.

The handles or sections 2 and 4 may be made entirely or partially of hard commercial grade plastic. The handles or sections 2 and 4 may be made entirely or partially of metal. Section 2a may have a plastic cover for comfort. The handle or section 4 may include a section 4g which may include a plastic covering which can be removed to access the motor 102 or other components. The section 4d may include a plastic covering. The battery 104 may be stored in the section 4b, which may have a removable covering.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first pliers handle having a first end and a second end;
a second pliers handle having a first end and a second end;
a first pivot pin which connects the first pliers handle, at a location between the first end and the second end of the first pliers handle and the second pliers handle at a location between the first end and the second end of the second pliers handle;
a first belt having teeth;
wherein the first belt having teeth is connected to the first pliers handle and located nearer the first end of the first pliers handle than to the second end of the first pliers handle;
wherein the first belt having teeth is connected to the second pliers handle and located nearer the first end of the second pliers handle than to the second end of the second pliers handle; and
wherein the first belt having teeth is configured to rotate while the first pliers handle remains stationary with respect to the second pliers handle.

2. The apparatus of claim 1 wherein
the first belt having teeth is configured to be detached from the first pliers handle and the second pliers handle.

3. The apparatus of claim 1 further comprising
a motor located within either the first or second pliers handle;
a power source located within either the first or second pliers handle;
and wherein the power source is configured to power the motor to rotate the first belt while the first pliers handle remains stationary with respect to the second pliers handle.

4. A method comprising
causing a first belt having teeth to rotate while a first pliers handle and a second pliers handle remain stationary;
wherein the first pliers handle has a first end and a second end;
wherein the second pliers handle has a first end and a second end;
wherein a first pivot pin which connects the first pliers handle to the second pliers handle, at a location between the first end and the second end of the first pliers handle and the second pliers handle at a location between the first end and the second end of the second pliers handle, so that the first pliers handle can rotate with respect to the second pliers handle;
wherein the first belt having teeth is connected to the first pliers handle and located nearer the first end of the first pliers handle than to the second end of the first pliers handle; and
wherein the first belt having teeth is connected to the second pliers handle and located nearer the first end of the second pliers handle than to the second end of the second pliers handle.

5. The method of claim 4 wherein
the first belt having teeth is configured to be detached from the first pliers handle and the second pliers handle.

6. The method of claim 4 wherein
the first belt having teeth is configured to be controlled by a motor located within either the first or second pliers handle;
wherein the motor is configured to be controlled by a power source located within either the first or second pliers handle;
and wherein the power source is configured to power the motor to rotate the first belt while the first pliers handle remains stationary with respect to the second pliers handle.
